(19) United States
(12) Patent Application Publication
(10) Pub. No.: US 2026/0304024 A1
(43) Pub. Date: Oct. 1, 2026

(54) SOUNDPROOF FLEXIBLE CUSHION, HEADPHONE CUSHION AND MANUFACTURING PROCESS THEREOF

(71) Applicant: WINIX KUO TAI CO., LIMITED, Hong Kong (CN)

(72) Inventor: Xiaoyu Xiong, Hong Kong (CN)

(21) Appl. No.: 19/095,061

(22) Filed: Mar. 31, 2025

(51) Int. Cl. H04R 1/10

(52) U.S. Cl. CPC H04R 1/1091; H04R 1/1008; H04R 1/1058; H04R 1/1083; H04R 2201/105

(57) ABSTRACT

A soundproof flexible cushion, a headphone cushion and a manufacturing process thereof are disclosed. The soundproof flexible cushion includes a flexible cushion body, a sealing soundproof member, and a soft rubber layer. The headphone cushion includes the soundproof flexible cushion and a soft outer covering. Through the design of the sealing soundproof member and the soft rubber layer, when the user wears and uses the finished headphone, the headphone cushion is squeezed, and the sealing soundproof member and the flexible cushion body protrude outward together. Tight fit between the sealing soundproof member and the soft outer covering of the headphone cushion improves the tightness of the fit.

### BACKGROUND OF THE INVENTION

### 1. Field of the Invention

The present invention relates to headphone accessories, and more particularly to a soundproof flexible cushion, a headphone cushion and a manufacturing process thereof.

### 2. Description of the Prior Art

In general, the ear cups of headphones are made of foam to ensure a soft and comfortable wearing experience. The edges of the foam are usually trimmed using a foam edge-cutting device to ensure a proper fit with the headphone casing. However, this trimming process leads to high foam loss and waste of resources.

Further, headphone cushions that use a single fabric layer to wrap the foam have a poor soundproof effect, affecting the sound quality of the headphones. Although technicians in the field have made a lot of efforts on how to improve the sound quality of headphones, for example, attaching an adhesive layer on the inside of the fabric layer. However, in actual use, when the headphones are compressed and deformed, cavities inevitably form between the fabric layer and the foam of the headphone cushion, leading to sound leakage. Besides, providing a soundproof layer on the fabric layer increases the overall thickness of the headphone. As a result, after the fabric layer wraps around the foam, wrinkles will form, affecting the precision of the covering and splicing process as well as the appearance of the earphone cushion.

Therefore, it is necessary to study a new technical solution to solve the above problems.

### SUMMARY OF THE INVENTION

In view of the deficiencies of the prior art, the primary object of the present invention is to provide a soundproof flexible cushion, a headphone cushion and a manufacturing process thereof. The soundproof flexible cushion includes a flexible cushion body, a sealing soundproof member, and a soft rubber layer. The headphone cushion includes the soundproof flexible cushion and a soft outer covering. Through the design of the sealing soundproof member and the soft rubber layer, when the user wears and uses the finished headphone, the headphone cushion is squeezed, and the sealing soundproof member and the flexible cushion body protrude outward together. Tight fit between the sealing soundproof member and the soft outer covering of the headphone cushion improves the tightness of the attachment. This maximally prevents gaps between the foam and the soft outer covering, thereby improving the airtightness of the headphone cushion, reducing sound leakage and improving the sound quality of the headphones effectively.

In order to achieve the above purpose, the present invention adopts the following technical solutions:

A soundproof flexible cushion comprises a flexible cushion body, a sealing soundproof member, and a soft rubber layer. The flexible cushion body has a front and an opposing back. The sealing soundproof member is disposed on the front and/or back of the flexible cushion body. The soft rubber layer is disposed on an outer side of the flexible cushion body.

A headphone cushion comprises a soundproof flexible cushion and a soft outer covering. The soundproof flexible cushion includes a flexible cushion body, a sealing soundproof member, and a soft rubber layer. The flexible cushion body has a front and an opposing back. The sealing soundproof member is disposed on the front and/or back of the flexible cushion body. The soft rubber layer is disposed on an outer side of the flexible cushion body.

A manufacturing process of a headphone cushion, comprising the following steps:
step 1: preparing a flexible cushion body, a protective film, a silicone sheet, a soft rubber member and a soft outer covering;
step 2: covering a front and/or back of the flexible cushion body with the protective film;
step 3: covering a front and/or back of the protective film with the silicone sheet to obtain a first-stage semi-finished product;
step 4: cutting the first-stage semi-finished product into strips to obtain a strip-shaped flexible cushion body;
step 5: coiling one end of the strip-shaped flexible cushion body toward another end of the strip-shaped flexible cushion body to form an annular flexible cushion body so that the silicone sheet is adhered to the front or back of the flexible cushion body;
step 6: covering a front and/or back of the sealing soundproof member with the soft rubber member to obtain a second-stage semi-finished product; and
step 7: covering the second-stage semi-finished product with the soft outer covering.

Compared with the prior art, the present invention has obvious advantages and beneficial effects. Specifically, it can be seen from the above technical solution that through the design of the sealing soundproof member and the soft rubber layer, when the user wears and uses the finished headphone, the headphone cushion is squeezed, and the sealing soundproof member and the flexible cushion body protrude outward together. Tight fit between the sealing soundproof member and the soft outer covering of the headphone cushion improves the tightness of the attachment. This maximally prevents gaps between the foam and the soft outer covering, thereby improving the airtightness of the headphone cushion, reducing sound leakage and improving the sound quality of the headphones effectively.

Further, one end of the flexible cushion body is coiled toward the other end of the flexible cushion body to form an annular flexible cushion body so that the silicone sheet is adhered to the front or back of the flexible cushion body. Thus, the strip-shaped flexible cushion body is in the form of a coil after being coiled, thereby improving the material utilization efficiency. The foam forms a coiled material after being coiled without generating waste, thereby reducing related procedures, improving production efficiency, and minimizing material loss.

### BRIEF DESCRIPTION OF THE DRAWINGS

FIG. 1 is a cross-sectional view of a flexible cushion body according to a first embodiment of the present invention;

FIG. 2 is a perspective view of an annular foam body according to the first embodiment of the present invention;

FIG. 3 is a cross-sectional view of the annular foam body according to the first embodiment of the present invention;

FIG. 4 is an enlarged view of circle a in FIG. 3;

FIG. 5 is a perspective view of a headphone cushion according to the first embodiment of the present invention;

FIG. 6 is a cross-sectional view of the headphone cushion according to the first embodiment of the present invention;

FIG. 7 is a cross-sectional view of the headphone cushion according to a second first embodiment of the present invention;

FIG. 8 is a cross-sectional view of the headphone cushion according to a third embodiment of the present invention;

FIG. 9 is a cross-sectional view of the flexible cushion body according to the second embodiment of the present invention; and

FIG. 10 is a cross-sectional view of the flexible cushion body according to the third embodiment of the present invention.

### DETAILED DESCRIPTION OF THE PREFERRED EMBODIMENTS

Embodiments of the present invention will now be described, by way of example only, with reference to the accompanying drawings.

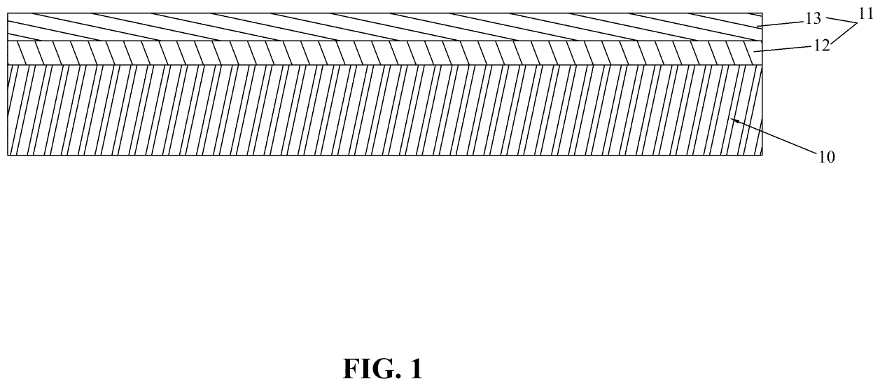

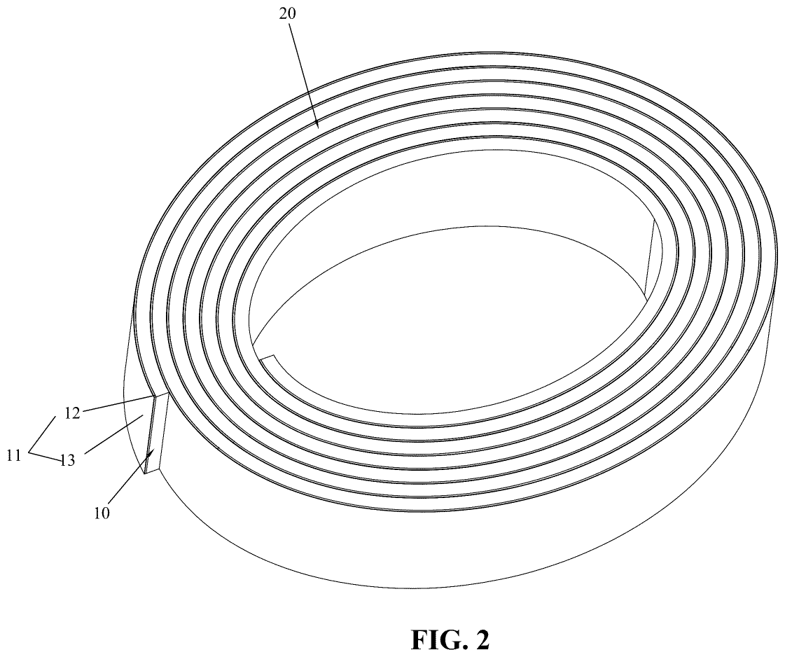

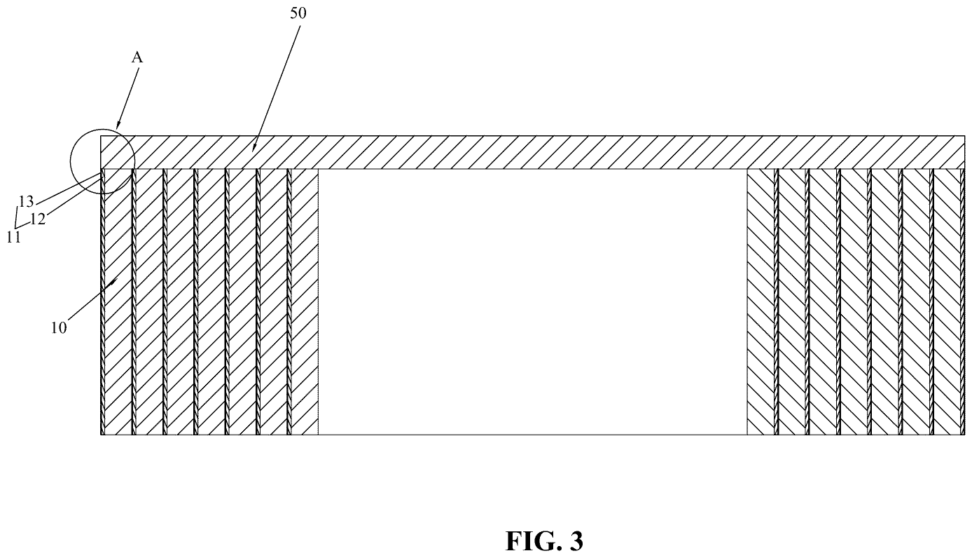

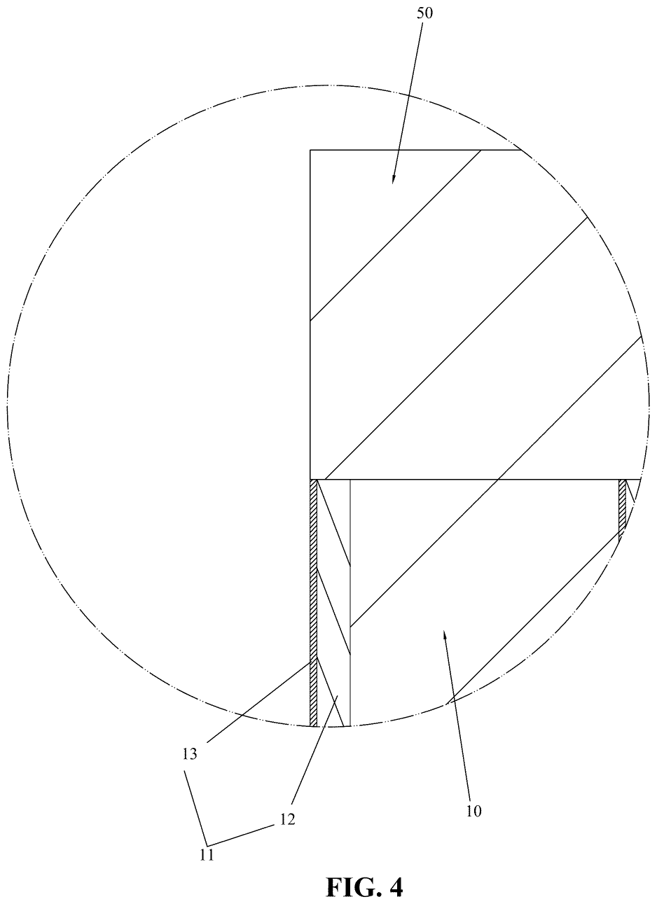

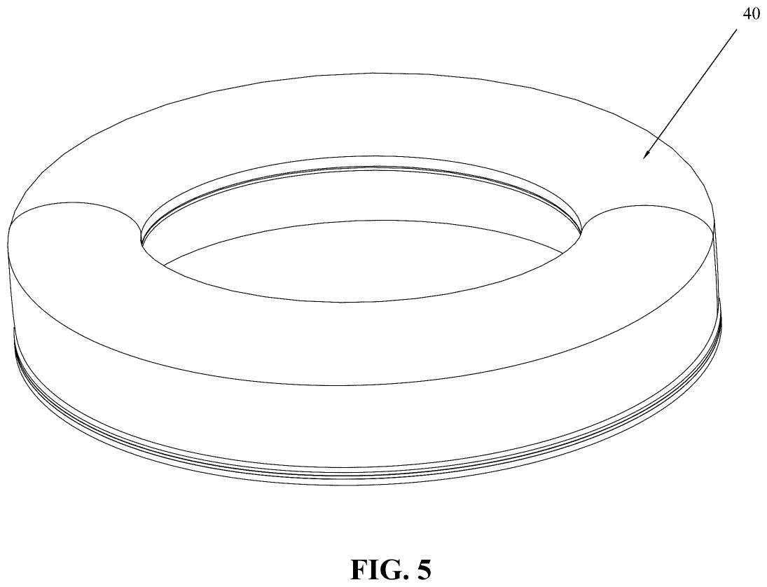

As shown in FIG. 1 through FIG. 10, the present invention discloses a soundproof flexible cushion 30, comprising a flexible cushion body 10, a sealing soundproof member 11, and a soft rubber layer 50.

The flexible cushion body 10 has a front and an opposing back. The sealing soundproof member 11 is disposed on the front and/or back of the flexible cushion body 10 for improving the soundproof effect. The soft rubber layer 50 is disposed on an outer side of the flexible cushion body 10.

The soft rubber layer 50 is disposed on the front and/or back of the sealing soundproof member 11. In this embodiment, the soft rubber layer 50 may be disposed on the upper end face and/or the lower end face and/or the circumferential face of the flexible cushion body 10. The soft rubber layer 50 may be disposed on a desired position according to the actual needs. Preferably, the soft rubber layer is deformable.

The soft rubber layer is annular. In this embodiment, the soft rubber layer may be circular, elliptical, racetrack-shaped, rectangular, etc., which may be selected according to the actual needs. An outer film is provided on the outer surface of the soft rubber layer, which is designed to reduce the adhesiveness of the outer surface of the soft rubber layer. The thickness of the soft rubber layer is 1 mm to 30 mm. The soft rubber layer may be made of a metallic rubber material or PU material or TPE material or TPU material or AB soft rubber. The corresponding material can be selected according to the actual needs.

Preferably, the flexible cushion body 10 is made of a foam material, sponge material or fiber material. Preferably, both end faces of the flexible cushion body 10 are tapered. Preferably, the thickness of the flexible cushion body 10 is 2 mm to 15 mm. The corresponding thickness can be selected according to the actual needs. Preferably, the flexible cushion body 10 is in the form of a long strip. There is no need for the width of the flexible cushion body 10 in the form of a long strip to be the same throughout the entire length.

A protective film 12 is provided on the front and/or back of the flexible cushion body 10. Preferably, the protective film 12 is a silicone film, PE film or plastic film. The material of the plastic film may be a PP material, PET material, PVC material, PA material, and the like. The corresponding material can be selected according to the actual needs.

In actual use, the protective film 12 is tightly attached to the flexible cushion body 10 for blocking the gaps on the flexible cushion body 10, thereby improving the tightness of the attachment. The silicone film is soft and flexible, which can better fit the contour of the human ear, reduce the pressure of the headphone on the ear, and make the ear feel more comfortable for long-time wearing. The silicone film has a good soundproof effect and can prevent sound leakage, which can reduce the interference of external noise on the music and prevent internal sound leakage from the headphone, allowing users to enjoy a clearer and purer auditory experience. This provides a relatively stable environment for sound transmission, allowing sound to be more focused as it enters the ear canal, thereby enhancing sound quality. For example, it improves the texture and volume of low frequencies while enhancing the expression of music.

The adhesiveness of the outer surface of the soft rubber layer can be reduced through the protective film or other means, such as applying a powder or applying a dryable liquid adhesive, so that the liquid adhesive dries to form a non-adhesive surface. The means to reduce the adhesiveness of the outer surface of the soft rubber layer can be selected according to the actual needs.

A silicone sheet 13 is adhered to the outside of the protective film 12. One end of the flexible cushion body 10 is coiled toward the other end of the flexible cushion body 10 to form an annular foam body 20, so that the silicone sheet 13 is adhered to the front or back of the flexible cushion body 10.

In this embodiment, the flexible cushion body 10 may be coiled to form multiple layers according to the actual needs, which will not be described in detail hereinafter. The flexible cushion body 10 may be coiled in an outside-in manner or in an inside-out manner to form an annular foam body. The manner to coil the flexible cushion body 10 can be selected according to the actual needs.

The flexible cushion body is integrally formed by stamping. In actual production, the protective film 12, the silicone sheet 13 and the soft rubber layer can be directly covered on the flexible cushion body that is integrally formed by stamping. This makes the forming of the flexible cushion body simple and fast. The corresponding forming method can be selected according to the actual needs, which will not be described hereinafter.

When the user wears and uses the finished headphone, the headphone cushion is squeezed, and the silicone sheet, the protective film and the annular foam body protrude outwardly together. Tight fit between the silicone sheet, the protective film and the soft outer covering of the headphone cushion improves the tightness of the attachment. This maximally prevents gaps between the foam and the soft outer covering, thereby improving the airtightness of the headphone cushion, reducing sound leakage and improving the sound quality of the headphones effectively.

FIG. 1 illustrates a first example of the flexible cushion body 10 of this embodiment. The protective film 12 is disposed on the front of the flexible cushion body 10. The silicone sheet 13 is adhered to the outside of the protective film 12.

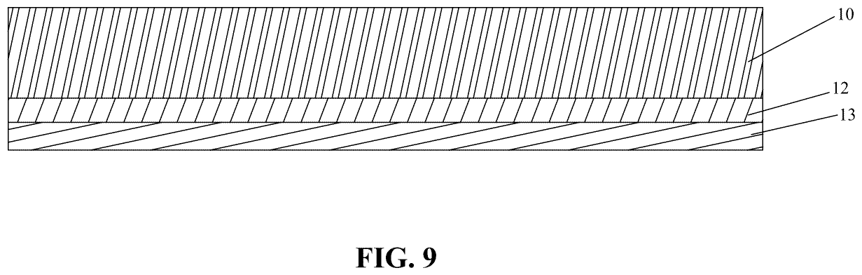

FIG. 9 illustrates a second example of the flexible cushion body 10 of this embodiment. The protective film 12 is disposed on the back of the flexible cushion body 10. The silicone sheet 13 is adhered to the outside of the protective film 12.

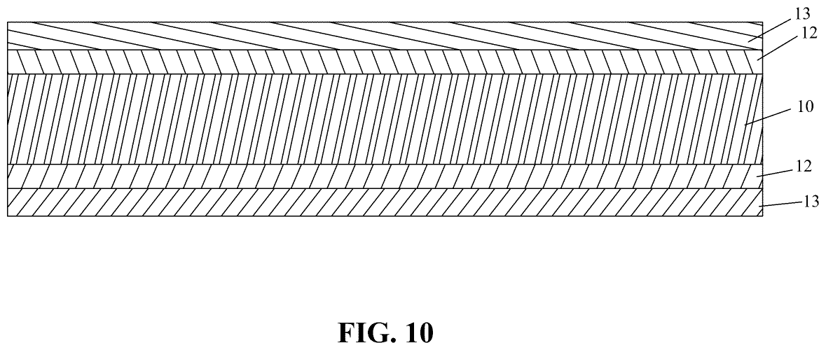

FIG. 10 illustrates a third example of the flexible cushion body 10 of this embodiment. The protective film 12 is disposed on the front and back of the flexible cushion body 10. The silicone sheet 13 is adhered to the outside of the protective film 12.

A headphone cushion comprises a foam 30 and a soft outer covering 40. The foam 30 is the foregoing soundproof flexible cushion 30. The soft outer covering 40 covers the outside of the foam 30. Preferably, the soft outer covering 40 is made of a leather material or fabric. Since only the foam 30 needs to be structurally improved, the design and application of the soft outer covering 40 are not limited. The soft outer covering 40 covers the foam 30 without wrinkles as in the conventional technique, reducing processing difficulty while ensuring the aesthetic appearance of the headphone cushion.

A headphone cushion comprises a soundproof flexible cushion 30 and a soft outer covering 40. The soundproof flexible cushion 30 includes a flexible cushion body, a sealing soundproof member 11, and a soft rubber layer 50. The flexible cushion body has a front and an opposing back. The sealing soundproof member 11 is disposed on the front and/or back of the flexible cushion body. The soft rubber layer is disposed on an outer side of the flexible cushion body.

Preferably, a soundproof block 60 is provided between the soft outer covering 40 and the soundproof flexible cushion. Preferably, the sealing soundproof member 11 includes a silicone sheet 13. The silicone sheet 13 is adhered to the front or back of the flexible cushion body. Preferably, the sealing soundproof member 11 further includes a protective film 12. The protective film 12 is disposed on the front and/or back of the flexible cushion body. The silicone sheet 13 is adhered to the outside of the protective film 12. Preferably, one end of the flexible cushion body is coiled toward the other end of the flexible cushion body to form an annular flexible cushion body. Preferably, the annular silicone sheet is adhered to the front or back of the annular flexible cushion body. Preferably, both end faces of the flexible cushion body are tapered. The flexible cushion body is made of a foam material, sponge material or fiber material. Preferably, the flexible cushion body is integrally formed by stamping. Preferably, the soft rubber layer is deformable.

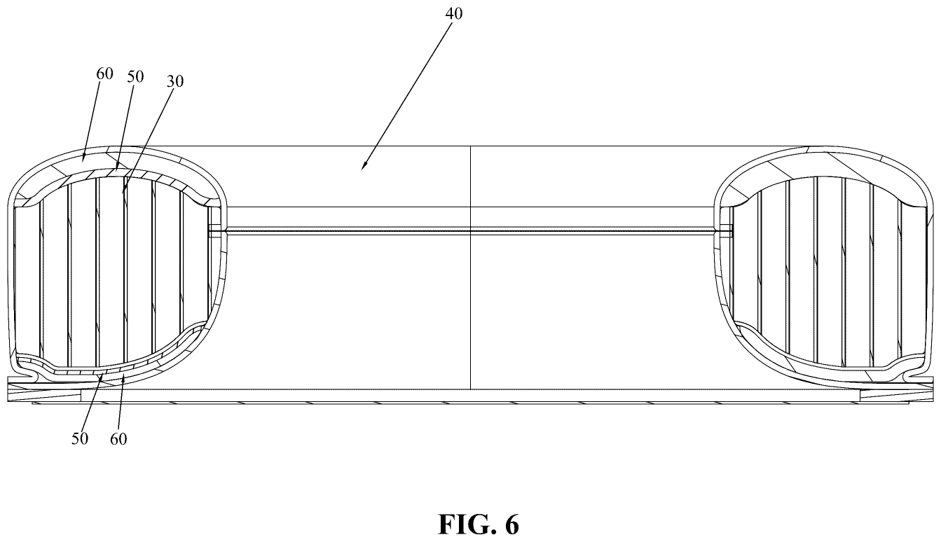

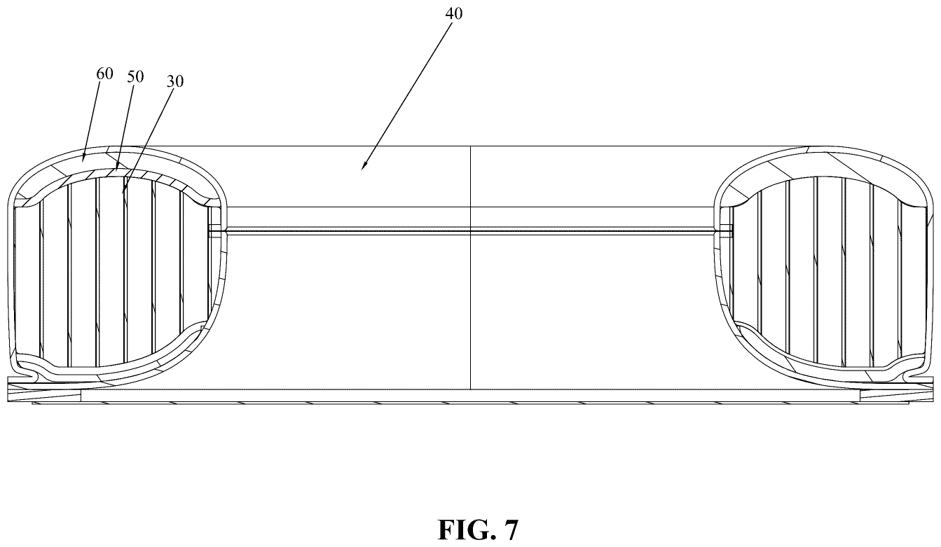

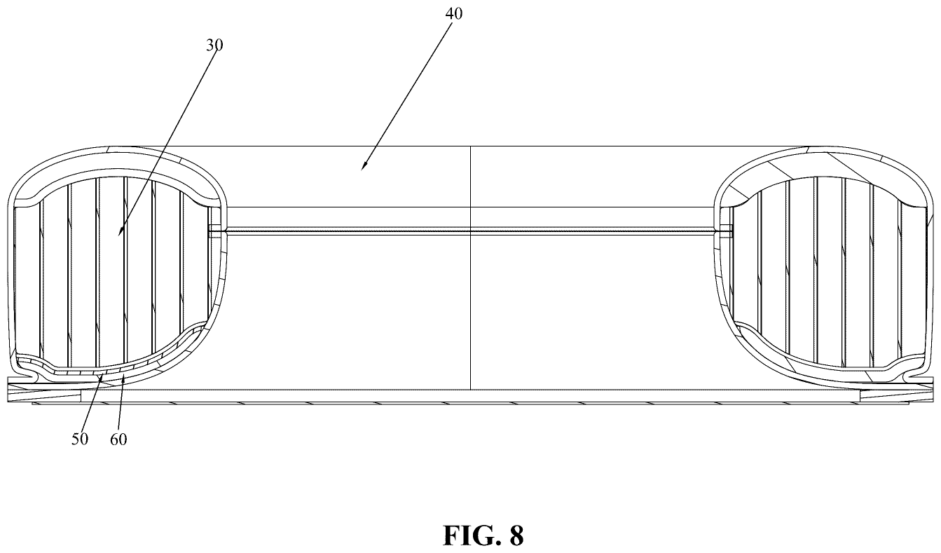

FIG. 6 illustrates the structure of the headphone cushion of a first embodiment. The soft rubber layer 50 is disposed on the front and back of the sealing soundproof member. FIG. 7 illustrates the structure of the headphone cushion of a second embodiment. The soft rubber layer 50 is disposed on the front of the sealing soundproof member. FIG. 8 illustrates the structure of the headphone cushion of a third embodiment. The soft rubber layer 50 is disposed on the back of the sealing soundproof member.

In this embodiment, for example, the soft rubber layer is disposed on the front and back of the sealing soundproof member. When the user wears the finished headphone, the design of the soft rubber close to one side of the ear enhances wearing comfort and provides a certain cooling effect, thereby improving the wearing experience of the headphones.

Preferably, a soundproof block 60 is provided between the soft outer covering 40 and the soundproof flexible cushion. The soundproof block 60 may be a sponge, or may be coated with polyurethane foam adhesive, soundproof sealant, silicone sealant, epoxy resin adhesive or neoprene adhesive on the foam, which can be selected according to the actual needs and will not be described in detail hereinafter.

A manufacturing process of a headphone cushion comprises the following steps:
step 1: preparing a flexible cushion body, a protective film, a silicone sheet, a soft rubber member and a soft outer covering;
step 2: covering the front and/or back of the flexible cushion body with the protective film;
step 3: covering the front and/or back of the protective film with the silicone sheet to obtain a first-stage semi-finished product;
step 4: cutting the first-stage semi-finished product into strips to obtain a strip-shaped flexible cushion body;
step 5: coiling one end of the strip-shaped flexible cushion body toward the other end of the strip-shaped flexible cushion body to form an annular flexible cushion body so that the silicone sheet is adhered to the front or back of the flexible cushion body;
step 6: covering the front and/or back of the sealing soundproof member with the soft rubber member to obtain a second-stage semi-finished product; and
step 7: covering the second-stage semi-finished product with the soft outer covering. Thus, the strip-shaped flexible cushion body is in the form of a coil after being coiled, thereby improving the material utilization efficiency. The foam forms a coiled material after being coiled, without generating waste, thereby reducing related procedures, improving production efficiency, and minimizing material loss.

What is claimed is:

1. A soundproof flexible cushion, comprising a flexible cushion body, a sealing soundproof member and a soft rubber layer, the flexible cushion body having a front and an opposing back; the sealing soundproof member being disposed on the front and/or back of the flexible cushion body, the soft rubber layer being disposed on an outer side of the flexible cushion body.

2. The soundproof flexible cushion as claimed in claim 1, wherein one end of the flexible cushion body is coiled toward another end of the flexible cushion body so that the flexible cushion body is in the form of an annular flexible cushion body.

3. The soundproof flexible cushion as claimed in claim 2, wherein the sealing soundproof member is adhered to the front or back of the annular flexible cushion body.

4. The soundproof flexible cushion as claimed in claim 1, wherein the sealing soundproof member includes a silicone sheet, and the silicone sheet is adhered to the front and/or back of the flexible cushion body.

5. The soundproof flexible cushion as claimed in claim 4, wherein the sealing soundproof member further includes a protective film, the protective film is disposed on the front and/or back of the flexible cushion body, and the silicone sheet is adhered to an outside of the protective film.

6. The soundproof flexible cushion as claimed in claim 1, wherein two end faces of the flexible cushion body are tapered; the flexible cushion body is made of a foam material, sponge material or fiber material.

7. The soundproof flexible cushion as claimed in claim 1, wherein the flexible cushion body is integrally formed by stamping.

8. The soundproof flexible cushion as claimed in claim 1, wherein the soft rubber layer is deformable.

9. A headphone cushion, comprising a soundproof flexible cushion and a soft outer covering, the soundproof flexible cushion including a flexible cushion body, a sealing soundproof member and a soft rubber layer, the flexible cushion body having a front and an opposing back; the sealing soundproof member being disposed on the front and/or back of the flexible cushion body, the soft rubber layer being disposed on an outer side of the flexible cushion body.

10. The headphone cushion as claimed in claim 9, wherein a soundproof block is provided between the soft outer covering and the soundproof flexible cushion.

11. The soundproof flexible cushion as claimed in claim 9, wherein one end of the flexible cushion body is coiled toward another end of the flexible cushion body so that the flexible cushion body is in the form of an annular flexible cushion body.

12. The soundproof flexible cushion as claimed in claim 11, wherein the sealing soundproof member is adhered to the front or back of the annular flexible cushion body.

13. The headphone cushion as claimed in claim 9, wherein the sealing soundproof member includes a silicone sheet, and the silicone sheet is adhered to the front and/or back of the flexible cushion body.

14. The soundproof flexible cushion as claimed in claim 13, wherein the sealing soundproof member further includes a protective film, the protective film is disposed on the front and/or back of the flexible cushion body, and the silicone sheet is adhered to an outside of the protective film.

15. The soundproof flexible cushion as claimed in claim 9, wherein two end faces of the flexible cushion body are tapered; the flexible cushion body is made of a foam material, sponge material or fiber material.

16. The soundproof flexible cushion as claimed in claim 9, wherein the flexible cushion body is integrally formed by stamping.

17. The soundproof flexible cushion as claimed in claim 9, wherein the soft rubber layer is deformable.

18. A manufacturing process of a headphone cushion, comprising the following steps:
step 1: preparing a flexible cushion body, a protective film, a silicone sheet, a soft rubber member and a soft outer covering;
step 2: covering a front and/or back of the flexible cushion body with the protective film;
step 3: covering a front and/or back of the protective film with the silicone sheet to obtain a first-stage semi-finished product;
step 4: cutting the first-stage semi-finished product into strips to obtain a strip-shaped flexible cushion body;
step 5: coiling one end of the strip-shaped flexible cushion body toward another end of the strip-shaped flexible cushion body to form an annular flexible cushion body so that the silicone sheet is adhered to the front or back of the flexible cushion body;
step 6: covering a front and/or back of the sealing soundproof member with the soft rubber member to obtain a second-stage semi-finished product; and
step 7: covering the second-stage semi-finished product with the soft outer covering.
